(19) United States
(12) Patent Application Publication
(10) Pub. No.: US 2019/0213328 A1
(43) Pub. Date: Jul. 11, 2019

(54) MODEL FOR DETECTION OF ANOMALOUS DISCRETE DATA SEQUENCES

(71) Applicants: Ran Yahalom, Kibbutz Tlalim (IL); Angel Progador, Lehavim (IL); Yuval Elovici, Moshav Arugot (IL)

(72) Inventors: Ran Yahalom, Kibbutz Tlalim (IL); Angel Progador, Lehavim (IL); Yuval Elovici, Moshav Arugot (IL)

(21) Appl. No.: 16/326,237

(22) PCT Filed: Aug. 23, 2017
(86) PCT No.: PCT/IL2017/050940

§ 371 Date: Feb. 18, 2019

Related U.S. Application Data
(60) Provisional application No. 62/378,966, filed on Aug. 24, 2016.

(51) Int. Cl. G06F 21/55; G06F 16/28

(52) U.S. Cl. CPC G06F 21/552; G06F 2221/034; G06F 16/285

(57) ABSTRACT

A system and methods are provided for detecting an anomalous discrete data sequence. The method includes applying a mapping function to a set of discrete data sequences to generate a first support level indicating affinity between the mapping function and the data set, adding a new discrete data sequence to the data set, calculating a second support level indicating affinity of the mapping function and the data set including the new discrete data sequence, calculating a support gain from a difference between the second support level and the first support level, and determining from the support gain an anomaly score indicating that the new discrete data sequence is anomalous, and thereby providing an anomaly indication of the new discrete data sequence to a system for classifying events.

### FIELD OF THE INVENTION

The present invention is directed to systems and methods of dynamic pattern finding, knowledge discovery, remote sensing and data classification. More specifically, the present invention is directed towards automatic detection of anomalous discrete data sequences.

### BACKGROUND

Data sets of discrete data sequences occur in many important computer domains, such as sequences of system calls made during software operation, sequences of transactions from online banking or customer purchases, and sensor readings communicated between multiple devices. Classification of discrete data sequences has multiple applications. One area of classification is the task of determining if sequences are similar or anomalous with respect to a given data set. Anomaly detection may be employed, for example, to determine from sensor readings that a machine or vehicle is not working properly. In computer-related domains, anomalous sequences may indicate cyber-attacks related to misuse, intrusion, or compromised security.

Detection of anomalous data has analogies in the field of immunology, whereby a living body develops antibodies that recognize foreign proteins. The field of developing this area of analogies is often referred to as artificial immunology.

The task of identifying similarities and differences between discrete data sequences may include the task of determining patterns common to the sequences, a form of “data mining”. Examples are described by: Reshamwala and Mahajan, “Prediction of DoS Attack Sequences”, International Conference on Communication, Information & Computing Technology (ICCICT), Oct. 19-20, 2012; Park et. al, U.S. Pat. No. 9,465,912; Agrawal and Srikant, “Mining sequential patterns,” ICDE '95 Proceedings of the Eleventh International Conference on Data Engineering, pp. 3-14, 1995.

### SUMMARY

Embodiments of the present invention provide methods and systems for detection of discrete data sequence anomalies in a manner founded upon principles of immunology and including steps similar to the process of immune synapse (IS) formation during T-cell selection in the thymus. According to embodiments of the present invention, a method for detecting an anomalous discrete data sequence in a system for classifying events, implemented by an information handling system that includes a memory and a processor, includes applying a mapping function to a set of discrete data sequences to generate a first support level indicating affinity between the mapping function and the data set. The method further includes adding a new discrete data sequence to the data set, calculating a second support level indicating affinity of the mapping function and the data set including the new discrete data sequence, calculating a support gain from a difference between the second support level and the first support level, determining from the support gain an anomaly score indicating that the new discrete data sequence is anomalous, and providing, according to the anomaly score, an anomaly indication of the new discrete data sequence to the system for classifying events.

According to further embodiments, the discrete data sequences may be sequences of multi-valued events. The discrete data sequences may also be temporal series of events.

In further embodiments, the set of discrete data sequences may be a base set of sequences of events, the mapping function may be a mapping set of sequences of events, generating the first support level may include generating a first set of interaction sequences, each interaction sequence of the first set representing affinities between sequential events of a sequence of the mapping set and sequential events of a sequence of the base set, generating the second support level may include generating a second set of interaction sequences, each interaction sequence of the second set representing affinities between sequential events of sequences of the mapping set and sequential events of sequences of the base set including the new discrete data sequence.

Generating the first support level may further include determining a first set of patterns in the first set of interaction sequences, generating the second support level may further include determining a second set of patterns in the second set of interaction sequences, patterns of each set may satisfy one or more pre-defined constraints, and the first and second support levels are indicative of the incidence of the first and second sets of patterns in the respective first and second sets of interactive sequences.

In some embodiments, the interaction sequences are temporally ordered, and the one or more pre-defined constraints include a sustainability constraint that a pattern shall appear as a common motif in interaction sequences generated within a predefined period of time. Alternatively or additionally, the one or more pre-defined constraints may include a frequency constraint that a pattern shall appear as a common motif within a minimum number of interaction sequences. Alternatively or additionally, the one or more pre-defined constraints include a recognition constraint that an aggregate affinity measure of the pattern shall exceed a pre-defined threshold, include the aggregate affinity measure is an aggregation of all of the affinities represented by the pattern.

In some embodiments, the affinities between paired sequential events may be determined by a predefined table or algorithm. Determining the second support level may further include iteratively adding additional copies of the new discrete data sequence to the data set and wherein determining the anomaly score from the support gain comprises modifying an anomaly score calculation by a factor related to the number of copies added.

There is further provided, according to embodiments of the present invention, a computing system including at least one processor and at least one memory communicatively coupled to the at least one processor including computer-readable instructions that when executed by the at least one processor cause the system to perform the steps of applying a mapping function to a set of discrete data sequences to generate a first support level indicating affinity between the mapping function and the data set; adding a new discrete data sequence to the data set; calculating a second support level indicating affinity of the mapping function and the data set including the new discrete data sequence; calculating a support gain from a difference between the second support level and the first support level; determining from the support gain an anomaly score indicating that the new discrete data sequence is anomalous, and responsively providing an anomaly indication of the new discrete data sequence to the system for classifying events.

The present invention will be more fully understood from the following detailed description of embodiments thereof.

### BRIEF DESCRIPTION OF DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows a schematic illustration of a process of mapping a data sequence to an interaction sequence, according to an embodiment of the present invention;

FIG. 2 shows an example of a mapping table applied to the process of FIG. 1, according to an embodiment of the present invention;

FIG. 3 shows a schematic illustration of a process of determining patterns from interaction sequences, according to an embodiment of the present invention;

FIG. 4 shows a schematic illustration of an anomaly detection process, for testing normality, or conversely, abnormality, of a new discrete data sequence, according to an embodiment of the present invention; and

FIG. 5 shows a flow diagram of a process for a discrete data sequence anomaly score calculation, according to an embodiment of the present invention.

### DETAILED DESCRIPTION OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

Embodiments of the present invention provide methods and systems founded upon principles of immunology that may be applied in a range of data processing domains in order to identify anomalous sequences. In particular, methods for constrained sequence mining described below, by which patterns are found in data sets of discrete data sequences, include some processes similar to the process of IS formation during T-cell selection in the thymus, called positive selection. As a T-cell matures in the thymus, T-cell receptors (TCRs) on the surface of the T-cell interact with the MHC complexes of Antigen Presenting Cells (APCs), in a process called APC scanning. During the process, MHC complexes present “self-peptides” to the T-cell, that is, peptides that are naturally present in the body. A TCR-MHC interaction leads to IS formation if there is sufficient affinity between the TCR and the MHC presented peptides and there enough such interactions occurring within a limited timeframe. The process of MHC-TCR interactions is reflected in the matching process between discrete data sequences described below with respect to embodiments of the present invention.

One pertinent aspect of such a biological analogy for a range of computer processing applications is that a data set of event sequences being processed typically includes too many events to permit economical processing of all possible subsequences of events (both contiguous and non-contiguous). Consequently, the full range of features that characterize “normal” sequences, as opposed to abnormal or anomalous is not certain or known. As described below, in embodiments of the present invention, a set of subsequences contained within sequences of the data set are identified as recurring patterns. Each pattern reflects one aspect of the normal data set or normal behavior of the underlying system that generated the data set. These subsequences are typically vectors of sets of discrete multi-valued items, or events. Often the events of the sequences described hereinbelow are ordered by time and one or more features of the events may be temporal, such as a time interval between items.

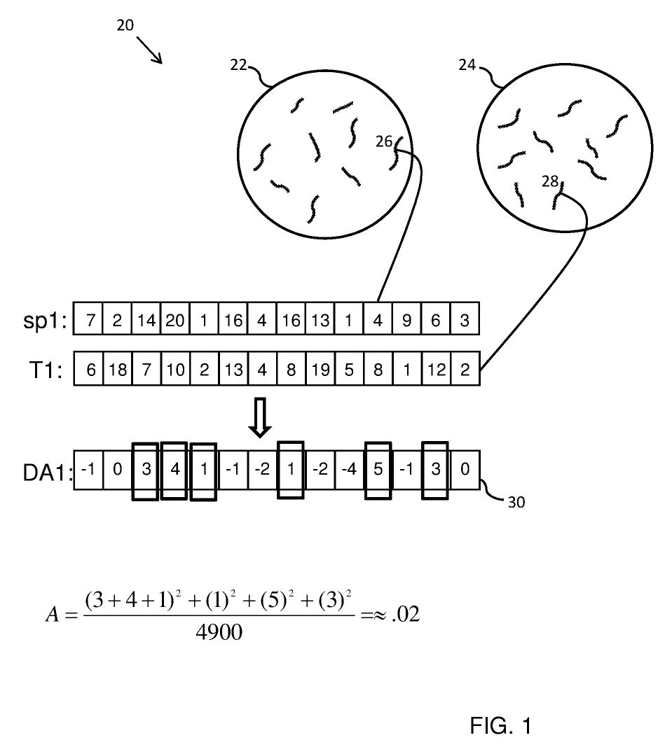

FIG. 1 shows a pictorial diagram of a mapping 20 between data sequences according to an embodiment of the present invention. The mapping shown is analogous to IS formation, as the data sequences can represent peptides that are sequences of amino acids.

Shown in the figure are two data sets, a base or “event” data set 22 and a mapping data set 24 (the base data set being analogous to a set of self-peptides and the mapping data set being analogous to a set of TCRs on T-cells in the thymus). Each data set may have a large number (for example, billions) of sequences. Many of the sequences may be either identical or have a high degree of similarity, such that the total number of unique or similar sequences is smaller than the total number of sequences (for example, thousands). The base data set includes all normal discrete data sequences, within the context of the given application, occurring prior to an anomaly test.

The mapping data set includes a set of mapping or conversion sequences. This data set may be generated by a stochastic model. More specifically, these mapping sequences are sequences of instructions/operations that can be applied to a data sequence of events in order to derive an interaction sequence, as will be explained below. Because of processing or storage constraints, generally not all data sequences are accessed or applied to the process of determining whether a new data sequence is anomalous.

In the example described here with respect to FIG. 1, the base data set is represented as including three types of unique sequences, sp1, sp2, and sp3, and the mapping data set is represented as including two types of unique sequences, T1 and T2. Sequences from each set are randomly selected and paired. For example, a base sequence 26 and a mapping sequence 28 may be selected, as indicated in the figure. The event sequence is an sp1 sequence, and the mapping sequence is a T1 sequence.

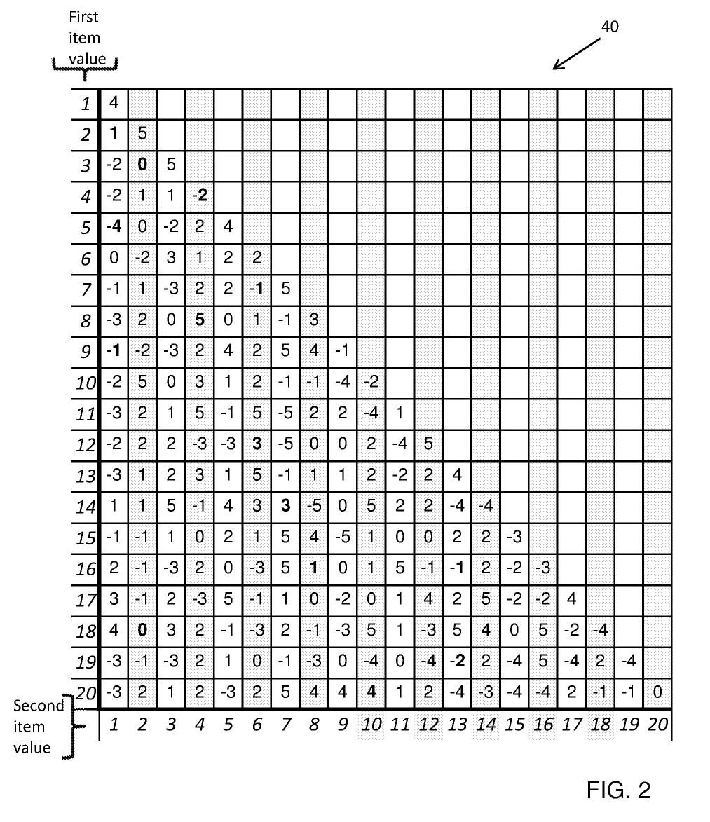

An interaction sequence 30, labeled as DA1, is generated by a matching between sp1 and T1. This matching reflects the pairwise affinity of events in the respective sp1 and T1 sequences. For every position j along the sequence, the pairwise affinity between event sp1j and event T1j is determined by invoking the operation encoded by T1j on sp1j. In the biological domain, affinity between pairs of amino acids, that is, pairwise contact potentials, may be estimated by means of an amino acid contact potential table. A similar mapping table used to generate DA1 is shown as table 40 in FIG. 2. Mapping table 40 is commutative, that is, the pairwise affinities listed are not dependent on the order of matching items in sequence pairs. Consequently, only half of the table is shown.

The first event in sequence sp1 is the value 7, and the first event in T1 is associated with the operation “derive contact potential with value 6 according to table 40”. According to table 40, the affinity value for the interaction of items having values 7 and 6, respectively, is <−1>; consequently the first item of interaction sequence DA1 has the affinity value <−1>. The first item of DA1 indicating a positive affinity is at position 3, which has the value <3>. This reflects the interaction of items having values of 14 and 7, according to table 40.

The mapping sequence, which includes an operation derived from an inherent mapping algorithm or table, can be considered as having mapped the event sequence to the interaction sequence. As indicated, the matching between sequences may include non-contiguous subsequences of affinity, interspersed with regions, or subsequences, of negative affinity, that is, regions that do not match. For simplicity the sequences shown include single-item events at each sequence position, but it should be readily apparent that the methods and systems described below may also be applied to data sequences of multi-item events. In some embodiments, items of each event may include, for example, a sensor measurement taken of some physical process, such as a temperature and/or pressure, as well as a time since a previous event.

The interaction sequence is thus understood to be a sequence of affinity values, each affinity value being a single value representing the affinity between an event of a sequence of the base set and an event of a sequence of the mapping set. From the aggregation of all affinity values of an interaction sequence, an aggregate affinity measure may be calculated, the algorithm employed depending on the domain of the application. Simple algorithms may, for example, include calculating the aggregate affinity measure as a sum of all pairwise matched affinity values or as the number of positive-valued matches in the interaction divided by the total number of matches. Other types of algorithms may be envisioned by a person skilled in the art, giving consideration to relevant characteristics of the domain providing the sequences. For a domain that models IS formation, an algorithm for calculating an affinity measure may be as follows: First, sums are calculated for all sets of adjoining positive affinities. Next, the sums are squared and the squares are themselves added together. Finally, the value is normalized between 0 and 1, by dividing the value calculated by the square of the maximum possible value. For the example shown, 5 is the maximum affinity at any single position, as indicated by table 40. Each sequence has 14 positions, so the square of the maximum possible sum of affinities is (14×5)²=4900. The affinity measure for DA1 may therefore be calculated, for the given example, as shown in the following equation (1):

$$\frac{{( 3 + 4 + 1 )}^{2} + ( {1}^{2} ) + ( {5}^{2} ) + ( {3}^{2} )}{4900} = \sim 0.02 \qquad ( 1 )$$

In embodiments of the present invention, the set of interaction sequences resulting from a series of pairwise matches are mined for patterns which satisfy a set of pre-defined constraints. For example, consider the following constraints:

Frequency constraint: requires that a pattern must have a minimum support, that is, the pattern must appear in at least a minimal number of interaction sequences from a given set of pairwise matches.

Recognition constraint: requires that patterns must have a minimal affinity (some domain specific function), such that the affinity measure exceeds a given threshold.

Motif constraint: requires that patterns must have a single motif, i.e. their occurrence in different sequences must all be represented by the same regular expression. A regular expression may include non-contiguous portions (“any” paired items), which may include sections of varying lengths and degrees of affinity.

Sustainability constraint: requires that for any pattern “s”, a timespan of no more than a given time period, denoted as maxSpan (J. Pei, J. Han, and W. Wang, “Constraint-based sequential pattern mining: The pattern-growth methods,” J. Intell. Inf. Syst., vol. 28, no. 2, pp. 133-160, 2007.), must include a certain number of interaction sequences that include a given pattern.

These four types of constraints on patterns represent constraints that are analogous to the immunological mechanism of IS formation, which generally includes multiple signaling events of short duration. Embodiments of the present invention may include one or more of these constraints, as well as additional constraints that will be readily apparent to the skilled practitioner, according to the data sets and/or logic in the given domain. In addition, embodiments may include applying industry standard data mining tools to identify various types of patterns appearing in interaction sequences, such as patterns that may be offset from the starting position of different interaction sequences. SPMF is an example of open-source data mining library including pattern searching tools that may be applied for this purpose, authored by Fournier-Viger, et al. and distributed under the General Public License (GPL) v3.0 of the GNU Project.

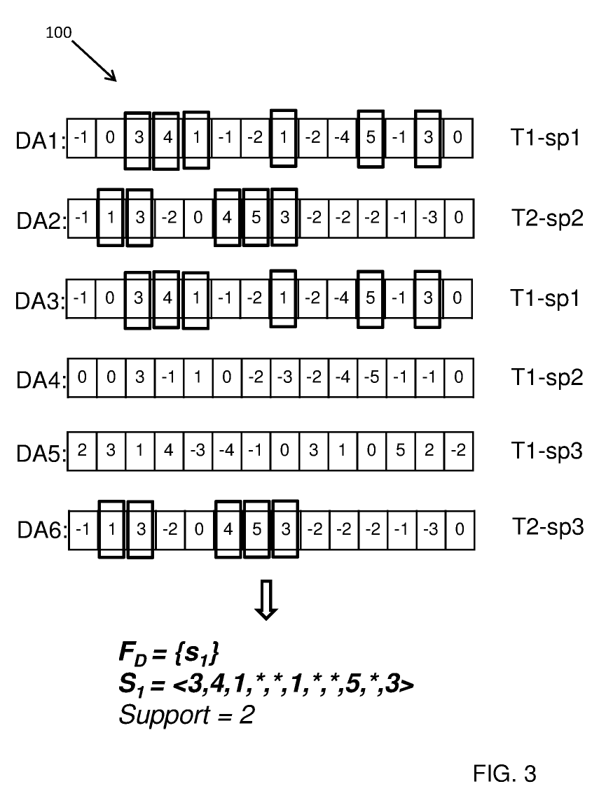

FIG. 3 shows a schematic illustration of a process 100 of applying constraints to determine patterns from interaction sequences, according to an embodiment of the present invention. As shown in the illustration, a subset of six randomly selected sequences is extracted from the base data set and each sequence is paired with a randomly selected sequence from the mapping data set. The pairwise matches are performed sequentially, resulting in six ordered, interaction sequences, DA1-DA6. As the sequences from each data set are chosen randomly and because there may also be repetitions of sequences as described above, there may be some repetition of pairwise matches; for example, DA1 and DA3 represent the same pairwise match, of T1 with sp1. Similarly, DA4 and DA5 represent pairwise matches of T1 and sp2.

The interaction sequences DA1 and DA3, as well as the interaction sequences DA2 and DA6 have common patterns that meet the “recognition” constraint described above, when the affinity measure threshold is set at 0.01, and the affinity measure for each interaction sequence is calculated according to the format of equation (1) above. Assuming that the minimum support threshold of the “frequency” constraint is also set to a minimum 2 sequences, then the pairs DA1 and DA3, as well as DA2 and DA6 also meet the “frequency” constraint. However, when the maxSpan threshold of the “sustainability” constraint is set to 2, meaning patterns must appear within the time span of one or two matches, only the interaction sequences DA1 and DA3 meet this third constraint of sustainability.

Consequently, DA1 and to DA3 pass all the constraints. The pattern common to the two sequences has the motif <3,4,1,*,*,1,*,*,5,*,3> as shown in the illustration and labelled as S1. The set of patterns, F_{D}, discovered in the set of interaction sequences therefore has this one member, S1. Because two interaction sequences have this pattern, DA1 and DA3, the “support level” for the affinity between the event data set and the mapping data set, based on the six pairings performed, is two. It should be noted that the support level is an indicator of how rare certain patterns are within the data sets, as it is assumed that all sequences have some minimal level of support, such that the total support would be 100% if all sequences of both data sets were compared.

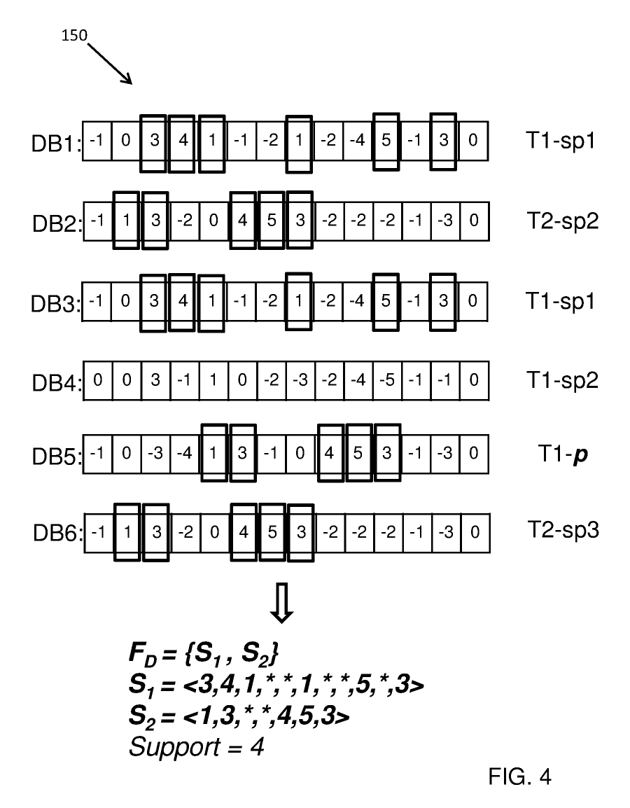

FIG. 4 shows a schematic illustration of an anomaly detection process 150 for testing normality, or conversely, abnormality, of a new discrete data sequence, according to an embodiment of the present invention. Given a new sequence “p”, the method provided by the present invention calculates an anomaly score by evaluating how similar “p” is to the repertoire of sequences in the event data set. The process includes iteratively adding copies of “p” to the event data set and observing the effect of each addition on the level of support when matched with sequences of the mapping data set (that is, on the outcome of positive selection, according to the IS analogy).

As shown in the illustration, the anomaly detection process performed is similar to the initial constrained pattern search process described above with respect to FIG. 3, the initial process being in some respects a form of classification “training”. The training process provides an initial value for “support”, as described above. For the anomaly detection process, a subset of six sequences are again randomly selected from the event data sets and are paired with a subset of six randomly selected sequences from the mapping data set. In addition, a copy of the “p” data sequence is added to the event sequence subset. The “p” copy may be in addition to the other event sequences, or may be instead of one of the event sequences, generally in a manner that is randomly determined. In either case, a subset of mapping sequences is also selected, generally in a random manner as described above with respect to the training process, the number of sequences in the mapping subset being equal to the number of sequences in the event subset. Pairwise matches are then performed sequentially, typically in parallel with the selection process.

The pairwise matching process results ordered, interaction sequences, DB1-DB6. As the sequences from each data set are chosen randomly, there may again be some repetition of matches.

After the interaction sequences are generated, data mining is performed to identify common patterns, which are then filtered by the constraints, as described above. In the example shown, the insertion of “p” results in two set of interaction sequences meeting all the pattern constraints, these being the pair DB1 and DB3, as well as the pair DB5 and DB6. The sequence patterns in common have the respective motifs <3,4,1,*,*,1,*,*,5,*,3> and <1,3,*,*,4,5,3>, labelled as S1 and S2, respectively. The set of patterns, F_{D}, discovered in the set of interaction sequences has these two members, S1 and S2. Because four interaction sequences each have at least one of these patterns, the “support level” is four. The “gain” of adding “p” to the event data subset is the difference between the training support level, which was two, and the new support level of four, that is, the gain is two.

Because the training and anomaly detection processes include random, non-deterministic selection and ordering of sequences, iteration of the anomaly detection process may lead to an “improved” gain. That is, a second “p” may be added to the event subset, again in a random position, and a new set of interaction sequences may be generated. The process may be repeated c times, until at most a pre-defined maxRep number of times is reached, or until a positive gain is calculated. The parameters of gain, g, and repetition, c, may then be used to calculate an “anomaly score”. For example, the following equation is one example of the type of calculation that might be performed to determine an anomaly score, AS:

$$AS = \frac{c}{( g - 1 ) + MinSup - 1} \qquad ( 2 )$$

As indicated by equation (2), the calculation of the anomaly score may also include additional parameters, such as a pre-defined constant MinSup, representing the “minimum support” required for a data sequence to be considered normal. The value of AS determined for the sequence “p” may then be compared to a pre-defined anomaly threshold to determine whether or not the sequence “p” is anomalous. In some embodiments, the anomaly threshold may be determined as the maximum of an AS value that would be obtained for any sequence measured from the event (sp) data set.

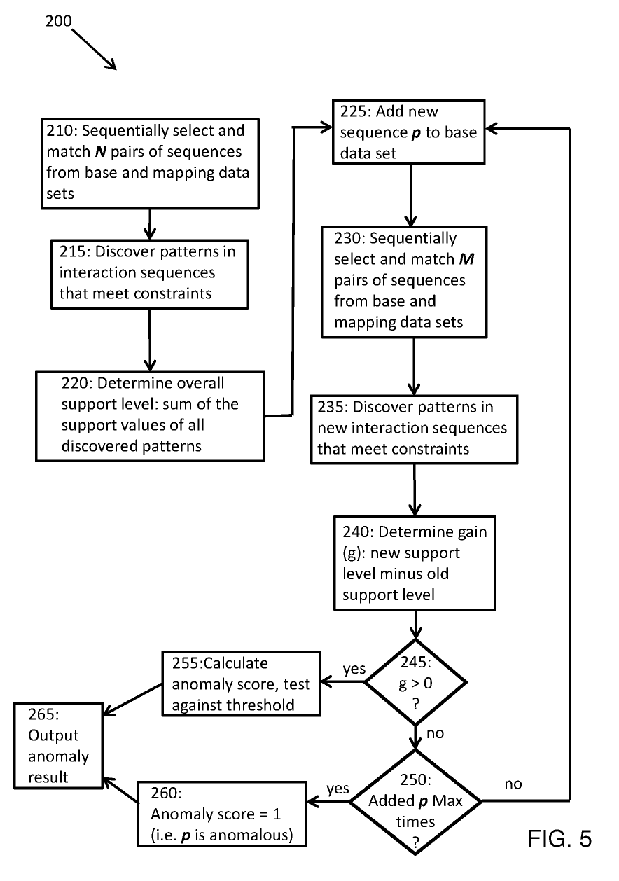

FIG. 5 shows a flow diagram of a process 200 for a discrete data sequence anomaly score calculation, according to an embodiment of the present invention.

At an initial step 210, pairs of sequences are selected and matched from the base and mapping data sets. In general, N pairs are selected randomly, where N is less than or equal to the total number of sequences in the smaller data set. Sequences may be selected with or without replacement; that is, sequences may or may not be selected multiple times. Matching of sequences is a form of mapping of event sequences to interaction sequences, as described above with respect to FIG. 1. The mapping process may also include reference to or application of a mapping algorithm or table. The mapping data set is applied in conjunction with the mapping table or algorithm to generate from the base data set a set of interactive sequences. The mapping function thus performed by the mapping data set and mapping table or algorithm may, in an alternative embodiment, be replaced by a mapping function.

At a step 215, patterns in interaction sequences are determined, according to pre-defined constraints. As described above, constraints may include frequency, recognition, motif, and sustainability parameters.

At a step 220, an algorithm is typically applied to calculate, from the discovered patterns, an overall “support level” pertaining to the relationship between the base and mapping data set. A simple algorithm may include summing the number of interaction sequences that include at least one discovered pattern. Other algorithms for calculating a support level may be apparent to the skilled practitioner, according to the characteristics of a given domain.

Steps 210 through 220 may be considered a “training” process, providing initial data on the support level of the base data set without adding a new, possibly anomalous sequence. Subsequently, at a step 225, a new sequence “p” to be tested for affinity/abnormality is added to the event data set, after which a process for determining a new support level is performed. The new process is an anomaly detection process that includes the steps 230 through 250 described below.

At step 230, M pairs of sequences from the base and mapping data sets are selected and matched, and new interaction sequences are generated. The number M is not necessarily the same as the number N applied in the training process above with respect to step 210. In some embodiments, the selection is constrained to include the new “p” in the subset of sequences that are paired.

At a step 235, patterns in the new interaction sequences are discovered that meet the constraints, which were also applied in the training process.

At a step 240, a “gain” (g) is determined as a difference between the new support level and the old support level. In further embodiments, the gain may be a ratio or other calculation that provides an indication of a difference.

At a step 245, if the gain is not greater than a threshold, typically set as zero, then the sequence “p” may warrant further testing. If “p” has not yet been added a “max” number of times to the event data set, where “max” is a pre-defined measure determined according to the given domain, then step 225 is repeated, that is, a new “p” is added to the event data set. Steps 230 through 250 are then repeated.

If at step 245, the gain is greater than the test threshold, typically zero, then “p” may have sufficient affinity to be considered “normal”. This is determined by a calculation at a step 255. An anomaly score, AS, for “p” is calculated, as described above, and the score is compared with a threshold. Typically the score is normalized within a range of 0 to 1. If the AS if greater than the threshold, then “p” is considered anomalous.

If at step 250 the addition of “p” is greater than the preset maximum number of additions, then “p” has not provided any improvement/gain relative the support. In this case, at a step 260, “p” is assigned an anomaly score of 1, that is, “p” is anomalous.

At a step 265, following either step 255 or 260, the result of the anomaly test is output to a system that will apply the test, typically a classification system in one of the domains described above (e.g., machine testing, computer operations, behavior analysis, etc.).

The methods and systems provided by the present invention could be applied to the variety of cyber security applications described hereinabove. Exemplary applications for the present invention also include screening visitors based on behavior patterns, whether visitors to a physical site or virtual visitors to a web site. Many different behavior patterns may be normal, and not all normal types are known, such that the IS model may be appropriate for such applications. Similarly, a computer application may receive new phrases from electronic surveillance of conversations, each phrase or syllable being an event of a sequence, which may be compared to randomly selected subsets of data sets of “normal” phrases. The system and methods of the present invention provide means for classifying varying “normal” patterns in real-time, as events being measured may be changing due to a wide range of environmental factors.

All or part of the processes 20, 100, 150 and 200 may be implemented in digital electronic circuitry, or in computer hardware, firmware, software, or in combinations thereof. All or part of the system and process may be implemented as a computer program product, tangibly embodied in an information carrier, such as a machine-readable storage device, for execution by, or to control the operation of, data processing apparatus, such as a programmable processor or on multiple computers at one site or distributed across multiple sites. Memory storage may include multiple distributed memory units, including one or more types of storage media. Network interface modules may control the sending and receiving of data packets over networks.

Method steps associated with the system and process can be rearranged and/or one or more such steps can be omitted to achieve the same, or similar, results to those described herein. It is to be understood that the embodiments described hereinabove are cited by way of example, and that the present invention is not limited to what has been particularly shown and described hereinabove. Rather, the scope of the present invention includes variations and modifications thereof which would occur to persons skilled in the art upon reading the foregoing description and which are not disclosed in the prior art.

1. A method of detecting an anomalous discrete data sequence in a system for classifying events, implemented by an information handling system that includes a memory and a processor, the method comprising:
applying a mapping function to a data set of discrete data sequences to generate a first support level indicating affinity between the mapping function and the data set;
adding a new discrete data sequence to the data set;
calculating a second support level indicating affinity of the mapping function and the data set including the new discrete data sequence;
calculating a support gain from a difference between the second support level and the first support level;
determining from the support gain an anomaly score indicating that the new discrete data sequence is anomalous, and responsively providing an anomaly indication of the new discrete data sequence to the system for classifying events.

2. The method of claim 1, wherein the discrete data sequences are sequences of multi-valued events.

3. The method of claim 1, wherein the discrete data sequences are temporal series of events.

4. The method of claim 1,
wherein the set of discrete data sequences is a base set of sequences of events,
wherein the mapping function comprises a mapping set of sequences of events,
wherein generating the first support level comprises generating a first set of interaction sequences, each interaction sequence of the first set representing affinities between sequential events of a sequence of the mapping set and sequential events of a sequence of the base set, and
wherein generating the second support level comprises generating a second set of interaction sequences, each interaction sequence of the second set representing affinities between sequential events of sequences of the mapping set and sequential events of sequences of the base set including the new discrete data sequence.

5. The method of claim 4,
wherein generating the first support level further comprises determining a first set of patterns in the first set of interaction sequences,
wherein generating the second support level further comprises determining a second set of patterns in the second set of interaction sequences,
wherein patterns of each set satisfy one or more pre-defined constraints, and
wherein the first and second support levels are indicative of the incidence of the first and second sets of patterns in the respective first and second sets of interactive sequences.

6. The method of claim 5, wherein the interaction sequences are temporally ordered, and wherein the one or more pre-defined constraints comprise a sustainability constraint that a pattern shall appear as a common motif in interaction sequences generated within a predefined period of time.

7. The method of claim 5, wherein the one or more pre-defined constraints comprise a frequency constraint that a pattern shall appear as a common motif within a minimum number of interaction sequences.

8. The method of claim 5, wherein the one or more pre-defined constraints comprise a recognition constraint that an aggregate affinity measure of the pattern shall exceed a pre-defined threshold, wherein the aggregate affinity measure is an aggregation of all of the affinities represented by the pattern.

9. The method of claim 4, wherein the affinities between paired sequential events are determined by a predefined table or algorithm.

10. The method of claim 1, wherein determining the second support level further comprises iteratively adding additional copies of the new discrete data sequence to the data set and wherein determining the anomaly score from the support gain comprises modifying an anomaly score calculation by a factor related to the number of copies added.

11. A computing system comprising at least one processor and at least one memory communicatively coupled to the at least one processor comprising computer-readable instructions that when executed by the at least one processor cause the system to perform the steps of:
applying a mapping function to a data set of discrete data sequences to generate a first support level indicating affinity between the mapping function and the data set;
adding a new discrete data sequence to the data set;
calculating a second support level indicating affinity of the mapping function and the data set including the new discrete data sequence;
calculating a support gain from a difference between the second support level and the first support level;
determining from the support gain an anomaly score indicating that the new discrete data sequence is anomalous; and
responsively providing an anomaly indication of the new discrete data sequence to a system for classifying events.
